(19) United States
(12) Patent Application Publication
(10) Pub. No.: US 2010/0008284 A1
(43) Pub. Date: Jan. 14, 2010

(54) RELAYING METHOD OF RELAY STATION(RS) USING A DIRECT RELAYING ZONE IN MULTIHOP RELAY SYSTEM

(76) Inventors: Su-Chang Chae, Daejeon-city (KR); Young-Il Kim, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/445,436

(22) PCT Filed: Oct. 12, 2007
(86) PCT No.: PCT/KR2007/005016

§ 371 Date: Apr. 13, 2009

(30) Foreign Application Priority Data
Oct. 13, 2006 (KR) 10-2006-0099946
Sep. 7, 2007 (KR) 10-2007-0091152

(51) Int. Cl. H04B 7/14

(52) U.S. Cl. 370/315

(57) ABSTRACT

Provided are a method of relaying a data burst in a relay station (RS) of a multi-hop relay (MMR) system using a direct relay zone, and a system using the method. The RS requests a base station to assign the direct relay zone in a frame in which a demodulation and forwarding scheme that demodulates, and then modulates and transmits a data burst is applied, receives an acknowledgement to the request from the base station, and relays a data burst using the frame in which the direct relay zone is assigned. Accordingly, since a data burst can be relayed within one frame, relay latency can be reduced.

### TECHNICAL FIELD

The present invention relates to a multi-hop relay system, and more particularly, to a method of relaying a data burst in a relay station, which demodulates a received signal without decoding, and then modulates and transmits the demodulated signal within a single frame, and a system using the method.

This work was supported by the IT R&D program of MIC/IITA[2006-S-011-01, Development of relay/mesh communication system for multi-hop WiBro].

### BACKGROUND ART

The Institute of Electrical and Electronics Engineers (IEEE) 802.16e working group (WG) is in the process of standardizing mobile multi-hop relay (MMR), and is actively participating in research into frame structures. In an MMR network, a relay station (RS) newly introduced between a base station (BS) and a mobile station (MS) of a conventional wireless broadband (WiBro) system transmits a signal between the BS and the MS. The MMR network has a BS-to-RS link and an RS-to-MS link. The WG aims to provide a simpler and cheaper RS than a BS, expand the cell radius of an MS, and improve the service transmission speed of the MS in a shadow region.

Since noise is amplified when a radio frequency (RF) input signal is amplified and transmitted as disclosed in Korean Patent Publication No. 2004-0037588, the RS in the conventional WiBro system cannot completely remove noise by using noise removal means. Accordingly, the RS in the conventional WiBro system is considered as a repeater.

Also, Korean Patent Publication No. 2003-0055915 discloses an RS using an interference cancellation system (ICS). In the RS, when transmitting and receiving antennas are not sufficiently separated from each other, such as in a WiBro system, a signal may be fed back from the transmitting antenna and received through the receiving antenna. Thus, a correction device is located between the transmitting and receiving antennas to offset the fed-back signal by a signal having a magnitude equal to and a phase opposite to those of the fed-back signal, thereby avoiding interference. The RS using the ICS can prevent amplification of noise, but cannot correct noise in an input signal. That is, errors included in the input signal accumulate as channel noise in the RS.

### DESCRIPTION OF THE DRAWINGS

FIG. 1 illustrates a frame structure used in a multi-hop relay (MMR) system according to an embodiment of the present invention.

FIG. 2A illustrates a symmetric complex frame structure used by a relay station (RS) of an MMR system according to an embodiment of the present invention.

FIG. 2B illustrates a frame structure used by an RS of an MMR system according to another embodiment of the present invention.

FIG. 2C is a flowchart illustrating a method of using a direct relay zone of the frame structure of FIG. 2B.

FIG. 3 illustrates an application example of an RS using a symmetric complex frame structure according to an embodiment of the present invention.

FIG. 4 illustrates an apparatus for generating a baseband signal in an RS according to an embodiment of the present invention.

FIG. 5 illustrates a method of generating a signal in an RS using a demodulation and forwarding scheme according to an embodiment of the present invention.

FIG. 6 illustrates channel coding parameters supporting a non-hybrid automatic repeat request (HARQ) of a conventional wireless broadband (WiBro) system.

FIGS. 7A and 7B illustrate extended channel coding parameters according to an embodiment of the present invention.

FIG. 8 illustrates a slot concatenation rule according to the extended channel coding parameters of FIGS. 7A and 7B.

FIG. 9 illustrates parameters according to a slot concatenation rule.

### DETAILED DESCRIPTION OF THE INVENTION

### Technical Problem

The present invention provides a method of relaying a data burst in a relay station (RS), which can reduce relay latency and efficiently use resources by demodulating a received data burst by using a direct relay zone without decoding, and then modulating and transmitting the demodulated data burst within one frame, and a system and a frame structure using the method.

### Technical Solution

According to an aspect of the present invention, there is provided a method of relaying a data burst in a relay station of a multi-hop relay system comprising a base station, the relay station, and a mobile station, the method comprising: requesting the base station to assign a direct relay zone in a frame in which a demodulation and forwarding scheme that demodulates, and then modulates and transmits a data burst is applied; and receiving an acknowledgement to the request from the base station.

According to another aspect of the present invention, there is provided a multi-hop relay system comprising a relay system relaying a data burst between a base station and a mobile station, wherein the relay station requests the base station to assign a direct relay zone in a frame using a demodulation and forwarding scheme, which demodulates, and then modulates and transmits a data burst, and receives an acknowledgement to the request from the base station.

According to another aspect of the present invention, there is provided a computer-readable recording medium having embodied thereon a program for executing a method of relaying a data burst in a relay station of a multi-hop relay system comprising a base station, the relay station, and a mobile station, wherein the method comprises: requesting the base station to assign a direct relay zone in a frame in which a demodulation and forwarding scheme that demodulates, and then modulates and transmits a data burst is applied; and receiving an acknowledgement to the request from the base station.

According to another aspect of the present invention, there is provided a computer-readable recording medium having embodied thereon a frame structure of a relay station comprising a downlink sub-frame and an uplink sub-frame in a multi-hop relay system comprising a base station, the relay station, and a mobile station, wherein the frame structure of the relay station comprises: a first direct relay zone located in the downlink sub-frame and using a demodulation and forwarding scheme that demodulates, and then modulates and transmits a data burst; and a second direct relay zone located in the uplink sub-frame and using the demodulation and forwarding scheme.

### ADVANTAGEOUS EFFECTS

According to the present invention, since a relay station (RS) demodulates a received signal without decoding, and then directly modulates and transmits the demodulated signal within one frame, relay latency can be prevented and resources can be managed efficiently.

### BEST MODE FOR INVENTION

According to an aspect of the present invention, there is provided a method of relaying a data burst in a relay station of a multi-hop relay system comprising a base station, the relay station, and a mobile station, the method comprising: requesting the base station to assign a direct relay zone in a frame using a demodulation and forwarding scheme that demodulates, and then modulates and transmits a data burst; and receiving an acknowledgement to the request from the base station.

According to another aspect of the present invention, there is provided a multi-hop relay system comprising a relay system relaying a data burst between a base station and a mobile station, wherein the relay station requests the base station to assign a direct relay zone in a frame using a demodulation and forwarding scheme, which demodulates, and then modulates and transmits a data burst, and receives an acknowledgement to the request from the base station.

According to another aspect of the present invention, there is provided a computer-readable recording medium having embodied thereon a program for executing a method of relaying a data burst in a relay station of a multi-hop relay system comprising a base station, the relay station, and a mobile station, wherein the method comprises: requesting the base station to assign a direct relay zone in a frame by using a demodulation and forwarding scheme that demodulates, and then modulates and transmits a data burst; and receiving an acknowledgement to the request from the base station.

According to another aspect of the present invention, there is provided a computer-readable recording medium having embodied thereon a frame structure of a relay station comprising a downlink sub-frame and an uplink sub-frame in a multi-hop relay system comprising a base station, the relay station, and a mobile station, wherein the frame structure of the relay station comprises: a first direct relay zone located in the downlink sub-frame and using a demodulation and forwarding scheme that demodulates, and then modulates and transmits a data burst; and a second direct relay zone located in the uplink sub-frame and using the demodulation and forwarding scheme.

### MODE OF THE INVENTION

The present invention will now be described more fully with reference to the accompanying drawings, in which exemplary embodiments of the invention are shown.

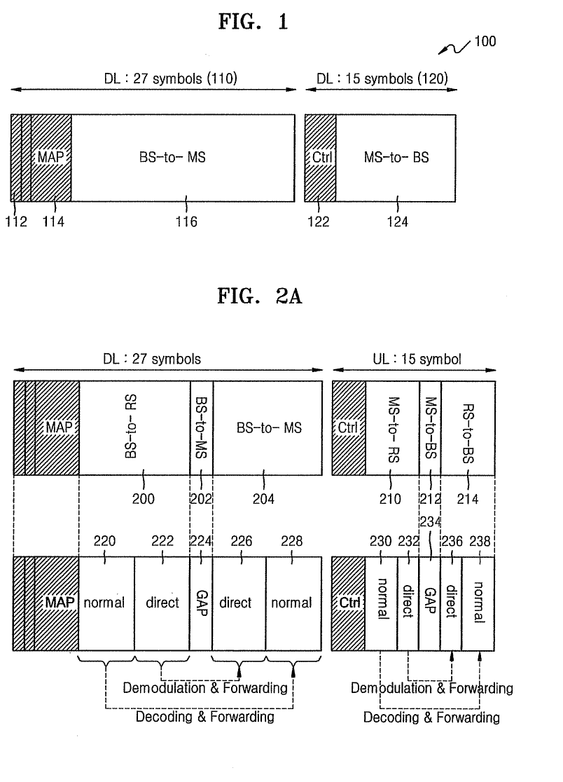

FIG. 1 illustrates a frame structure used in a multi-hop relay (MMR) system.

Referring to FIG. 1, a frame 100 is divided by time division duplex (TDD) into a downlink (DL) sub-frame 110 and an uplink (UL) sub-frame 120 on a time axis, and comprises 1024 carriers defined by orthogonal frequency multiple access (OFDMA) on a frequency axis. 48 carriers constitute a sub-channel which forms one time slot. Accordingly, one frame consists of 16 sub-channels.

The DL sub-frame 110 in which data is transmitted from a base station (BS) to a mobile station (MS) includes a preamble 112, an MAP 114, and a broadcast data and user data zone 116, and is 27 symbols long. The UL sub-frame 120 in which data is transmitted from the MS to the BS includes a control channel 122 and a user data zone 124, and is 15 symbols long.

The MS of a physical (PHY) layer receiving a frame from the BS demodulates and decodes user data existing in the DL sub-frame, and transmits user data having a length that is shorter than a predetermined limit to a media access control (MAC) layer within a current frame time and user data having a length that is greater than the predetermined limit to the MAC layer after one frame time. When preparation of data for the UL sub-frame is completed by using the data transmitted to the MAC layer, the MS of the PHY layer encodes and modulates the prepared data and then transmits the encoded and modulated data to the BS.

A relay station (RS) relaying a signal between the BS and the MS in the MMR system regenerates a signal received from the BS and sends the regenerated signal to the MS in downlink transmission, and regenerates a signal received from the MS and sends the regenerated signal to the BS in uplink transmission.

Since a wireless broadband (WiBro) system adopts a TDD communication scheme, when one RS is added between the BS and the MS, one downlink is divided into two downlinks. That is, a downlink is divided into BS-to-RS and RS-to-MS links. Of course, there is also a link between the BS and the MS without passing through the RS, that is, a BS-to-MS link. Hence, the MMR system has a topology including at least three links.

When the MMR system has the topology including at least three links, the domain occupied by each of the three links in one frame is divided on a time axis. When one link is divided into two links in the MMR system, that is, when one RS is added between the BS and the MS, the number of hops is 2, and when two RSs are added between the BS and the MS, the number of hops is 3. Accordingly, when multiple hops are formed by adding several RSs, communication can be made with an MS beyond the cell radius of the BS by extending coverage. However, the time division of one frame according to the number of hops has a disadvantage in that, since timedomain should be added to the frame as the number of hops increases, resources allocated in each timedomain are reduced. However, the time division of one frame according to the number of hops has an advantage in that frame latency does not occur as the number of hops increases.

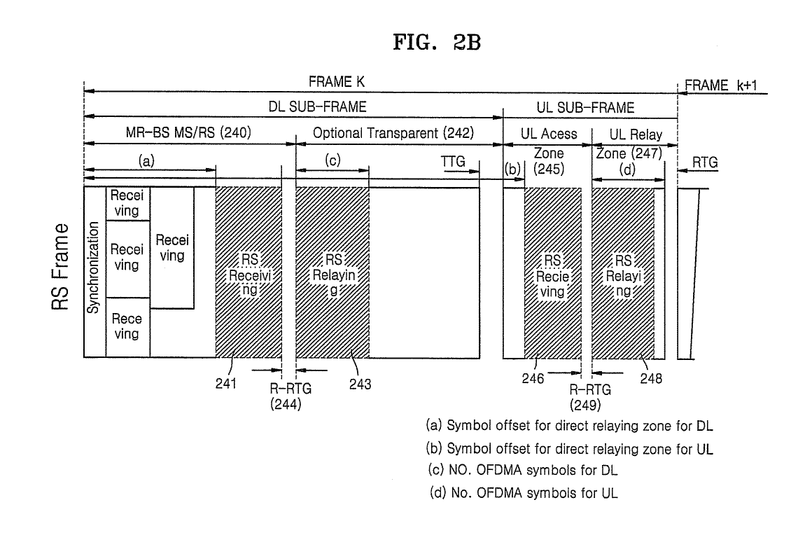

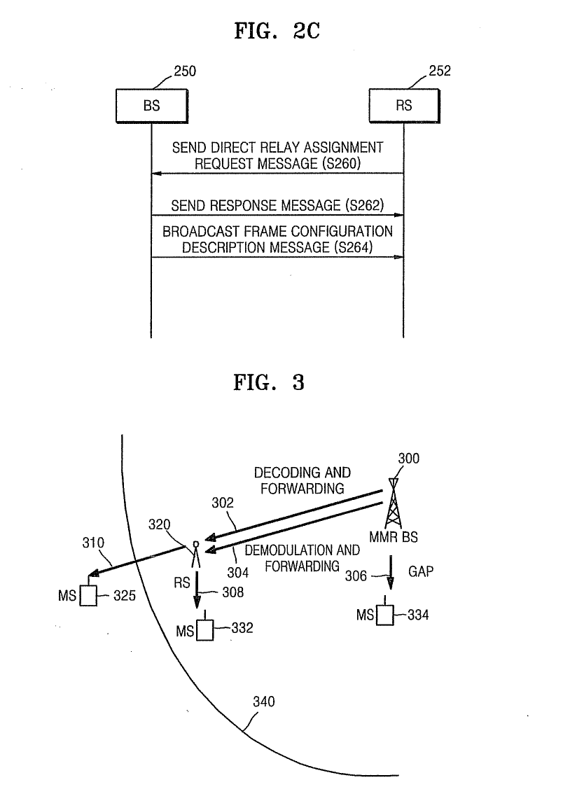

FIG. 2A illustrates a symmetric complex frame structure used by an RS of an MMR system according to an embodiment of the present invention.

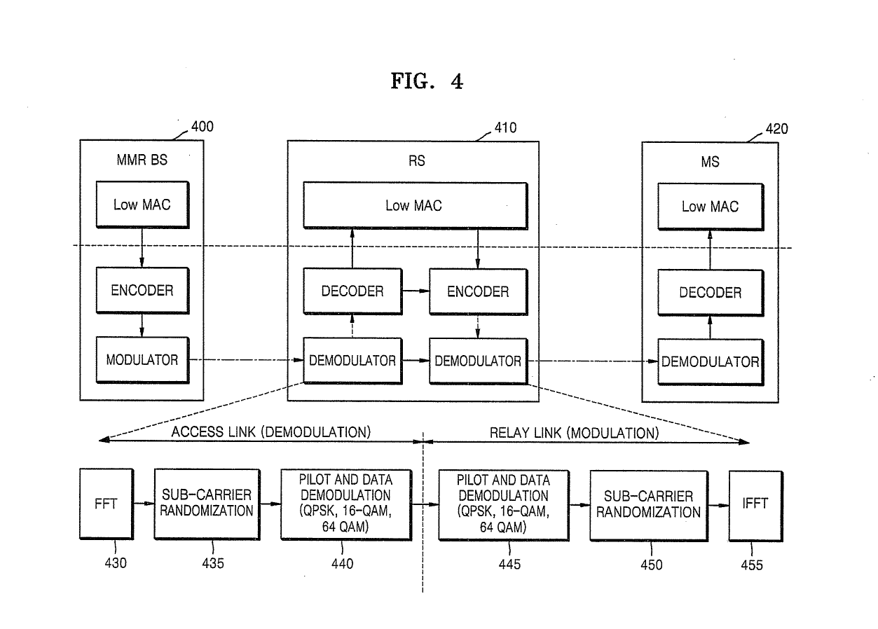

Referring to FIG. 2A, a time domain occupied by three links, that is, BS-to-RS, RS-to MS, and BS-to-MS links, of the MMR system in a frame is divided in downlink transmission. However, since domain latency occurs in a BS-to-RS zone 200, gap zones 202 and 224 are needed in a downlink sub-frame. The gap zones 202 and 224 may be used only for the BS-to-MS link. According to the present embodiment, since the gap zones 202 and 224 are reduced to 2 symbols, resources allocated to the BS-to-RS link and RS-to-MS link can be increased and an overall throughput can be enhanced, which will be explained later in detail with reference to FIG. 4.

In the operation of a modem, a received signal is demodulated for every symbol. That is, a fast Fourier transform (FFT) operation and demapping are repeatedly performed for every symbol. Accordingly, demodulation latency corresponds to one symbol. Demodulated data is input to a channel decoder. Since channel decoding is performed for every user data burst, channel decoding latency may be several symbols. Hence, gap zones are proportional to the number of bursts processed by the RS. Accordingly, each GAP zone is at least 1 symbol long, and is increased and defined by each symbol.

Accordingly, the BS-to-RS zone 200 of the frame of FIG. 2A is divided into a normal zone 220 and a direction zone 222, and an RS-to-MS zone 204 is divided into a direction zone 226 and a normal zone 228 in a symmetric manner with respect to the BS-to-RS zone 200. The frame also includes the gap zone 224 between the BS-to-RS zone 200 and the RS-to-MS zone 204. Likewise, an MS-to-RS zone 210 of an uplink sub-frame is divided into a normal zone 230 and a direct zone 232, and an RS-to-BS zone 214 of the uplink sub-frame is divided into a direct zone 236 and a normal zone 238. A gap zone 234 is located between the MS-to-RS zone 210 and an RS-to-MS zone.

The present embodiment demodulates a signal without channel decoding, and then modulates and generates a signal. Bursts in the normal zone 220 of the BS-to-RS zone 200 and the normal zone 230 of the MS-to-RS zone 210, requiring channel decoding, are allocated to the normal zone 228 of the RS-to-MS zone 204 and the normal zone 238 of the RS-to-BS zone 214, which are farther away from the gap zone 224, and bursts in the direct zone 222 of the BS-to-RS zone 200 and the direct zone 232 of the MS-to-RS zone 210, which are only demodulated and modulated, are allocated to the direct zone 226 of the RS-to-MS zone 204 and the direct zone 236 of the RS-to-BS zone 214, which are closer to the gap zone 224. Accordingly, the bursts which are only demodulated are first modulated and transmitted through a demodulation and forwarding scheme, and then the decoded bursts are encoded, modulated, and transmitted through a decoding and forwarding scheme.

When an RS is located between a BS and an MS in the symmetric complex frame structure according to the present embodiment, latency does not occur irrespective of the number of RSs and any signal can be transmitted within one frame. However, as the number of hops increases, resources allotted to each timeslot decrease. A throughput enhancement C_{TH} according to the number of hops is shown below.

$${C}_{TH} = C ( \frac{1}{{T}_{hop} + 1} + {m}_{r} \frac{1}{{T}_{hop} + 1} ) \qquad ( 1 )$$

where Tₕₒₚ denotes the number of hops and is equal to or greater than 2, C denotes a maximum transmission capacity when there is no RS, and mᵣ denotes modulation orders (quadrature phase shift keying (QPSK)=1, 16 quadrature amplitude modulation (QAM)=2, and 64 QAM=3).

It is assumed the gap zone 224 required due to modem latency in the RS is located between the BS-to-RS zone 200 and the RS-to-MS zone 204, only a capacity increases as the modulation order mᵣ increases, and resources of the BS-to-MS link are allocated in the gap zone 224. In the case of 2 hops, the throughput enhancement C_{TH} increases by as much as 30% with respect to the maximum transmission capacity C. In the case of 3 hops, an increase in the throughput is little.

The present embodiment uses either one of the decoding and forwarding scheme and the demodulation and forwarding scheme according to the channel state of the MS. Accordingly, in the case of the symmetric complex frame structure of FIG. 2A, the throughput enhancement C_{TH} is rendered as

$${C}_{TH} = C ( \frac{{N}_{GAP} ( {T}_{hop} - 1 ) + {m}_{r} \frac{( {N}_{sym} - {N}_{GAP ( {T}_{hop} - 1 ) )}}{{T}_{hop}}}{{N}_{sym}} ) \qquad ( 2 )$$

where N_{GAP} denotes the number of symbols in each GAP zone, and N_{Sym} denotes the number of total symbols.

In order to apply Equation 2 to a downlink, when a maximum throughput is calculated assuming that the number of symbols in each gap zone is 2 and the number of total symbols is 25, the throughput enhancement C_{TH} increases by as much as 50% in the case of 2 hops and there is little increase in the throughput enhancement C_{TH} in the case of 3 hops.

FIG. 2B illustrates a frame structure used by an RS of an MMR system according to another embodiment of the present invention.

Referring to FIG. 2B, a frame is divided into a downlink (DL) sub-frame and an uplink (UL) sub-frame. The DL sub-frame includes an access zone 240 in which a BS transmits data to an RS or an MS, and an optional transparent zone 242 in which the RS transmits data to its subordinate RS or MS. The UL sub-frame includes a UL access zone 245 and a UL relay zone 247.

Each of the UL and DL sub-frames includes a direct relay zone in which a received data burst is demodulated without decoding or encoding, and then modulated and transmitted. The direct relay zone in each of the UL and DL sub-frames comprises direct receiving zones 241 and 246, direct transmitting zones 243 and 248, and gap zones 244 and 249 located between the direct receiving zones and the direct transmitting zones. The direct receiving zone 241 of the DL sub-frame is located in the access zone 240, and the direct transmitting zone 243 of the DL sub-frame is located in the optional transparent zone 242. The direct receiving zone 246 of the UL sub-frame is located in the UL access zone 245 and the direct transmitting zone 248 of the UL sub-frame is located in the UL relay zone 247.

For example, the RS receiving a frame from the BS or its superordinate RS demodulates a data burst of the direct receiving zone 241 of the DL sub-frame of the frame without decoding, modulates the demodulated data burst, allocates the modulated data burst to the direct transmitting zone 243 of the optional transparent zone 242, and transmits the allocated data burst to the MS or its subordinate RS. Likewise, the RS receiving a frame from the MS or its subordinate RS demodulates a data burst of the direct receiving zone 246 of the UL sub-frame of the frame without decoding, modulates the demodulated data burst, allocates the modulated data burst to the direct transmitting zone 248 of the UL sub-frame, and transmits the allocated data burst to the BS or its predominant RS. That is, the RS uses a demodulation and forwarding scheme that demodulates a signal of a direct relay zone without decoding, modulates the demodulated signal, and transmits the modulated signal.

In order to define a direct relay zone of a frame according to the present embodiment, information regarding: (a) a symbol offset for a position where a direct relay zone of the DL sub-frame starts, (b) a symbol offset for a position where a direct relay zone of the UL sub-frame starts, (c) the number of OFDMA symbols of the direct relay zone of the DL sub-frame, and (d) the number of OFDMA symbols of the direct relay zone of the UL sub-frame, is necessary. Such information is one example of what is necessary for defining the direct relay zone in the frame. There are many other methods of defining the direct relay zone shown in FIG. 2B, and various modifications can also be made.

FIG. 2C is a flowchart illustrating a method of using a direct relay zone of FIG. 2B.

Referring to FIG. 2C, a BS 250 may optionally assign a direct relay zone aforementioned with reference to FIG. 2B, to an RS 252. Through the direct relay zone, the RS 252 can relay data within one frame by using a demodulation and forwarding scheme. In the demodulation and forwarding scheme, the RS 252 demodulates and deinterleaves a received burst without decoding, and then interleaves, modulates, and transmits the burst. Here, the (de)interleaving may be selectively included.

For the purpose of direct relaying, in operation S260, the RS sends a direct relay request message to the BS 250. That is, the RS 252 requests the BS 25 to acknowledge the request using the frame structure of FIG. 2B. In operation S262, the BS 250 sends a direct relay response message indicating acknowledgement to the direct relay request to the RS 252. Examples of the direct relay request message include an SBC-REQ message including a type-length-value (TLV) for the direct relay zone, and examples of the direct relay assignment request response message include an SBC-RSP message. The TLV included in the SBC-REQ message and the SBC-RSP message is used to indicate a capability of the demodulation and forwarding scheme using the direct relay zone. For example, when the RS 252 sends a direct relay request message including a TLV, indicating a request to use the direct relay zone, to the BS 250, the BS 250 sends a direct relay response message including a TLV, indicating acknowledgement to the direct relay request to the RS. For example, when a TLV field is 1, it is an indication that the RS 252 can use the demodulation and forwarding scheme using the direct relay zone. The RS 252 receives the direct relay response message indicating acknowledgement to the direct relay request and relays data using the frame including the direct relay zone.

The direct relay zone of the frame is configured using a frame configuration description message including information regarding the arrangement of the direct relay zone in the frame. In operation S264, the BS 250 broadcasts the frame configuration description message. The frame configuration description message can be broadcast at any time before the RS 250 directly relays data. For example, the frame configuration description message may be received when a network is configured, at a predetermined interval, or while the direct relay response message is sent. One example of the frame configuration description message may be an RS-configuration description (CD) message defined in IEEE 802.16j.

Examples of information included in the frame configuration description message for describing the arrangement of the direct relay zone in the frame include:

(a) the existence of a direct relay zone indicating whether a direct relay zone exists in each of a DL sub-frame and a UL sub-frame;

(b) an offset for a direct receiving zone indicating an OFDMA symbol offset for a position where a direct receiving zone starts in each of the DL sub-frame and the UL sub-frame;

(c) the number of OFDMA symbols in the direct receiving zone, indicating the number of OFDM symbols which the RS should demodulate and modulate in the direct relay zone, in each of the DL sub-frame and the UL sub-frame.

(d) an offset for a direct transmitting zone indicating an OFDMA symbol offset for a position where a direct transmitting zone starts in each of the DL sub-frame and the UL sub-frame; and

(e) the number of OFMD symbols in the direct transmitting zone, indicating the number of OFDM symbols which the RS should demodulate and modulate in the direct relay zone, in each of the DL sub-frame and the UL sub-frame.

Here, a forward error correction (FEC) block size of a data burst in a relay link between the BS and the RS should be the same as that of a data burst of an access link between the RS and the MS.

FIG. 3 is an application example of an RS using a symmetric complex frame structure according to an embodiment of the present invention.

Referring to FIG. 3, a BS 300 can communicate with MSs 332 and 334 inside a WiBro cell and with an MS 325 outside the WiBro cell through an RS 320. The basic purpose of an RS in an MMR system is to extend a cell radius and increase data transfer rates with MSs within the cell radius.

The RS 320 uses a decoding and forwarding scheme or a demodulation and forwarding scheme to regenerate a modem signal. In the decoding and forwarding scheme, the RS 320 demodulates and decodes received data and corrects errors, and then re-encodes, modulates, and transmits the data to the MS. In the demodulation and forwarding scheme, the RS only demodulates received data, and then modulates and transmits the data to the MS.

The decoding and forwarding scheme can be used in a poor environment where the MS 325 exists outside a cell area 340 of the BS 300 and a channel state is poor, whereas the demodulation and forwarding scheme can be used when the received and transmitted signal strength of the RS 320 is sufficiently higher than that of the MS 332 and a channel state is good. Of course, there may be a link where the MS 334 and the BS 300 directly communicate with each other without the RS because a channel state is very good.

When comparing the application example of FIG. 3 and the frame structure of FIG. 2A, 220 corresponds to 302, 222 corresponds to 304, 224 corresponds to 306, 226 corresponds to 308, and 228 corresponds to 310. The correspondence is also the same in regard to the UL sub-frame.

FIG. 4 illustrates an apparatus for generating a baseband signal in an RS according to an embodiment of the present invention.

Referring to FIG. 4, an MMR system includes a BS 400, an RS 410, and an MS 420. The BS 400 includes a low MAC, an encoder, and a demodulator. The RS 410 includes a demodulator, a decoder, a low MAC, an encoder, and a modulator. The MS 420 includes a low MAC, a decoder, and a modulator. Since the encoders, decoders, modulators, and demodulators are well known in this field, a detailed explanation thereof will not be given here.

In a decoding and forwarding scheme, the RS 410 decodes a signal, and then re-encodes, modulates, and transmits the signal to the MS 420. Accordingly, since latency may be lengthened in the RS, data bursts using the decoding and forwarding scheme are allocated to normal zones 220, 228, 230, and 238 of a frame as shown in FIG. 2A. On the other hand, data bursts using a demodulation and forwarding scheme, which only demodulates a signal, and then directly modulates and transmits the signal to the MS 420, are allocated to direct zones 222, 226, 232, and 236 of the frame. Demodulation and modulation latency corresponds to one symbol. That is, referring to FIG. 4, each of FFT 430, and demappings 435 and 440 and mappings 445 and 450 consumes ⅓ of a symbol time, and an IFFT 455 consumes ⅓ of a symbol time. Accordingly, a time taken to demodulate and then modulate one symbol is equal to a time taken to perform FFT, demapping and mapping, and IFFT, also is equal to a sum of ⅓ of a symbol time, ⅓ of a symbol time, and ⅓ of a symbol time, and also is equal to a 1 symbol time. Accordingly, since latency corresponding to 1 symbol occurs, each of gap zones 224 and 234 of the frame as shown in FIG. 2A can be reduced to 1 symbol. A time taken to perform each of the (de)mapping and IFFT/FFT can be reduced to ⅓ of a symbol time by increasing a reference clock speed three times or more.

The decoding and forwarding scheme channel decodes and encodes, and then modulates and transmits a signal to the MS, and the demodulation and forwarding scheme maintains a code rate and changes only a modulation method to regenerate a signal, thereby reducing the size of resources allocated to the regenerated signal.

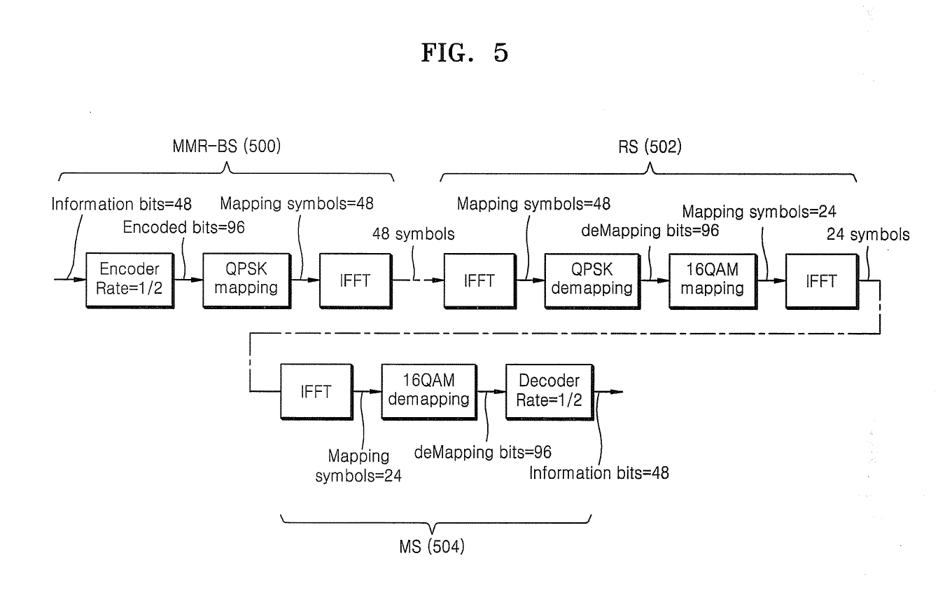

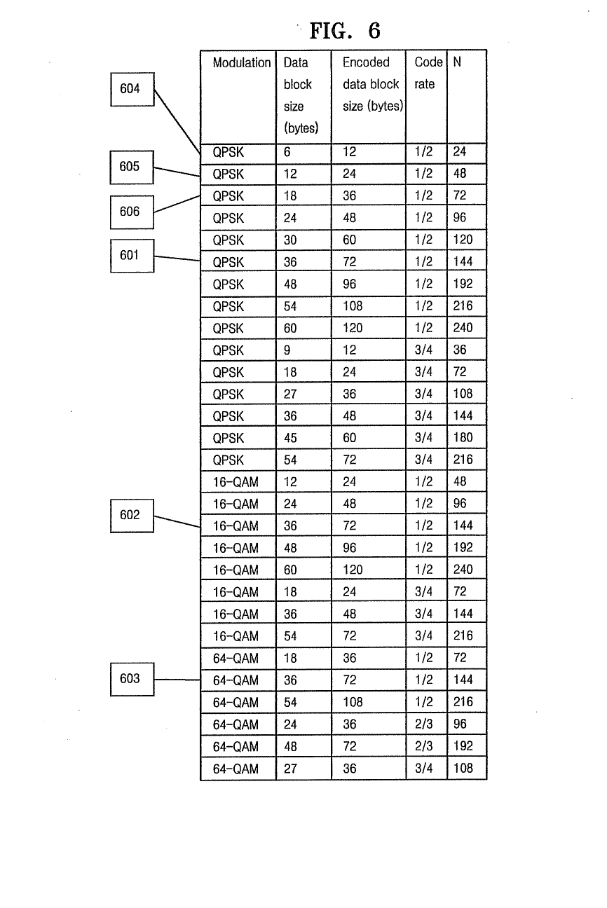

FIG. 5 illustrates a method of generating a signal in an RS using a demodulation and forwarding scheme according to an embodiment of the present invention.

Referring to FIG. 5, a communication channel between a BS 500 and an RS 502 has a better state than a communication channel between the RS 502 and an MS 504. Data is transmitted using QPSK to a BS-to-RS link and data is transmitted using 16 QAM to an RS-to-MS link.

When 48 information bits are encoded at a code rate of ½ in the BS 500, 96 bits are obtained. When the 96 bits are modulated, since 2 bits are mapped to one symbol, 48 symbols are obtained in total. In order to regenerate a signal using a demodulation and forwarding scheme, the RS 502 receiving the 48 symbols demodulates the 48 symbols using QPSK and modulates the demodulated 48 symbols using 16 QAM. The symbols demodulated using QPSK become 96 bits. When the 96 bits are mapped again using 16 QAM, since 4 bits become one symbol, 24 symbols are obtained in total. The RS 502 transmits the 24 symbols to the MS 504. The MS 504 receiving the 24 symbols demodulates the symbols using 16 QAM to obtain the original 96 bits, decodes the 96 bits again, corrects error, and obtains 48-bit data. At this time, a code rate for the 48 information bits should not be changed and only a modulation order should be changed.

Accordingly, channel coding parameters according to the present embodiment are defined so that the same code rate can be used for information bits although modulation orders are different in order to use the demodulation and forwarding scheme. That is, channel coding parameters supporting a non-hybrid automatic repeat request (HARQ) of a conventional WiBro system are shown in FIG. 6. In FIG. 6, when a code rate for 36-bytes is ½, only a modulation order can be changed from QPSK 601 to 16 QAM 602, and also from 16 QAM 602 to 64 QAM 603. In this case, the number of symbols transmitted from the RS 502 to the MS 504 of FIG. 5 is reduced to ⅓. QPSK can be directly changed to 64 QAM. In even this case, the number of symbols transmitted from the RS 502 to the MS 504 of FIG. 5 is reduced to ⅓. Accordingly, the size of resources allocated in the frame can be reduced.

FIG. 6 illustrates channel coding parameters supporting non-HARQ of a conventional WiBro system.

Referring to FIG. 6, since a standard used in the conventional WiBro system should be applied without change to the MS 504, the parameters shown in FIG. 6 are used in the RS-to-MS link. However, in FIG. 6, some parameters are defined in the case of a modulation order but are not defined in the case of another modulation order. Accordingly, when the undefined parameters are additionally defined in the BS-to-RS link, the parameters defined in the conventional WiBro standard of FIG. 6 can be used as they are.

For example, in FIG. 6, when 6 bytes are used as information, parameters exist in the case of a modulation order QPSK, but do not exist in the case of 16 QAM and 64 QAM. Also, parameters for 12-byte data are defined in the case of 64 QAM, but are not defined in the case of 16 QAM. Accordingly, the undefined parameters may be additionally defined to be applied to the BS-to-RS link.

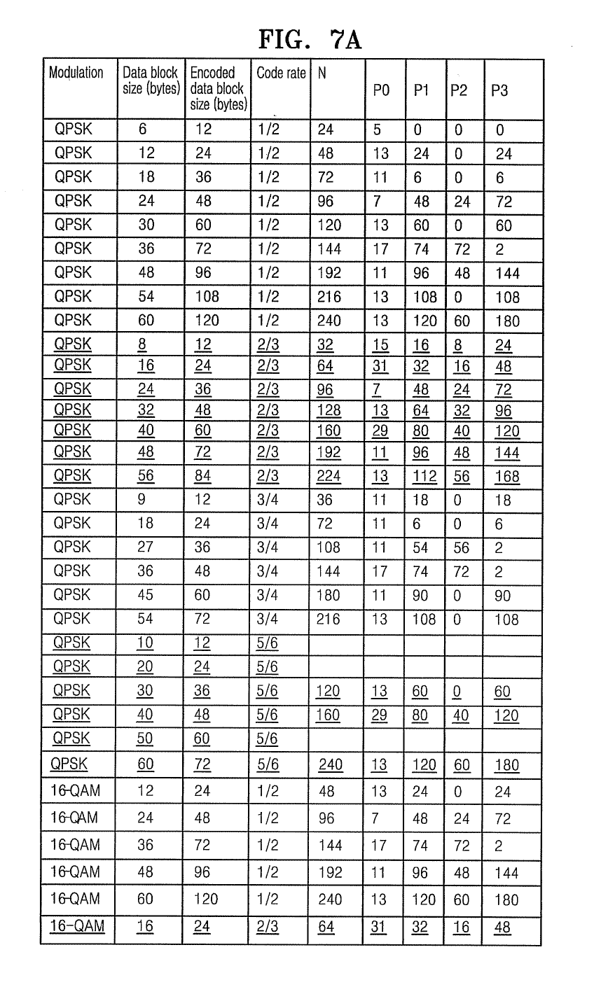

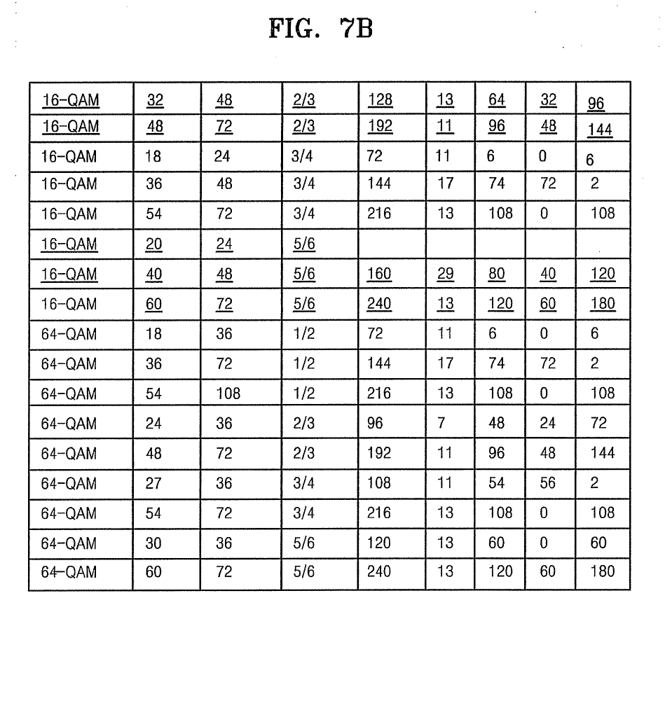

FIGS. 7A and 7B illustrate extended channel coding parameters according to an embodiment of the present invention.

Referring to FIGS. 7A and 7B, the extended channel coding parameters include parameters added to the parameters defined in the conventional WiBro standard of FIG. 6 such that the extended channel coding parameters can be applied to BS-to-RS and RS-to-BS links. The extended channel coding parameters include all code block sizes for code rates of ½, ¾, and ⅔ respectively in the case of modulation orders QPSK, 16 QAM, and 64 QAM. In FIGS. 7A and 7B, underlined parameters are the newly added parameters.

In order to use a modulation and coding set (MCS) of the BS-to-RS link and an MCS of the RS-to-MS link in a different manner, in the decoding and forwarding scheme, a signal is generated by changing a modulation order and a code rate.

In the demodulation and forwarding scheme, the BS should satisfy the following slot boundary condition so as to change only a modulation order and generate a signal.

n_{A}·m_{A}−n_{R}·m_{R} (3)

Slot boundary condition:

where n_{A} denotes the number of slots allocated in a UL access zone, n_{B} denotes the number of slots allocated in a UL relay zone, m_{A} denotes modulation orders (QPSK=2, 16 QAM=4, and 64 QAM=6) in the UL access zone, and mB denotes modulation orders (QPSK=2, 16 QAM=4, and 64 QAM=6) in the UL access zone.

Accordingly, in order to use all MCSs supported by the conventional MS in the demodulation and forwarding scheme, MCSs (16 QAM ⅔, ⅚ and 64 QAM ⅔, ⅚) are added in the MR-BS as shown in the extended MCS of FIGS. 7A and 7B.

The extended channel coding parameters also include all parameters related to a channel encoding method. For example, parameters required by a convolution turbo code (CTC) interleaver are varied according to code block sizes. The extended channel coding parameters according to the present embodiments also include parameters not only in a non-HARA mode but also in a HARQ mode.

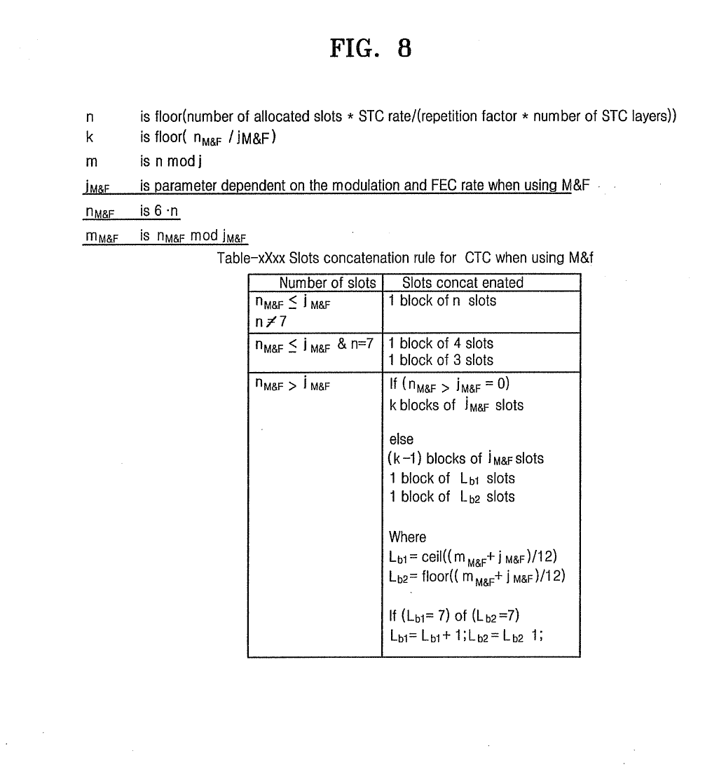

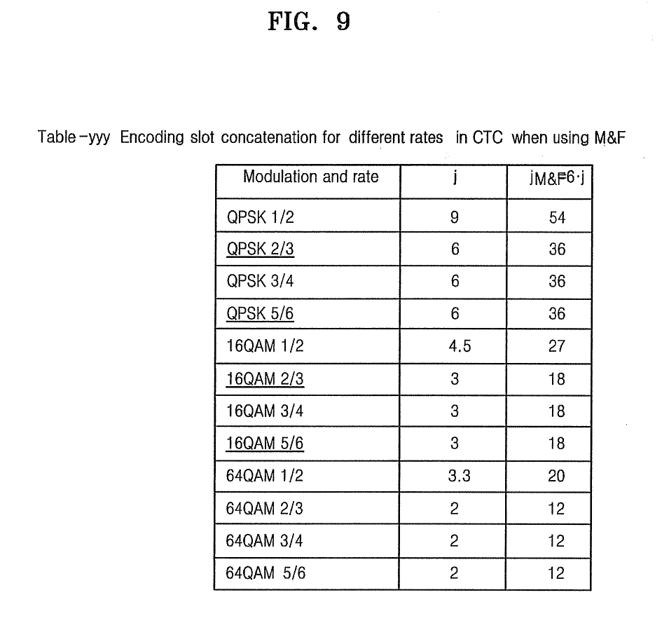

FIG. 8 illustrates a slot concatenation rule according to the extended channel coding parameters of FIGS. 7A and 7B. FIG. 9 illustrates parameters according to a slot concatenation rule.

The present invention may be embodied as computer readable codes on a computer readable recording medium. The computer readable recording medium is any data storage device that can store data which can be thereafter read by a computer system. Examples of the computer readable recording medium include read-only memories (ROMs), random-access memories (RAMs), CD-ROMs, magnetic tapes, floppy disks, and optical data storage devices. The computer readable recording medium can be dispersively installed in a computer system connected to a network, and stored and executed as a computer readable code in a distributed computing environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of relaying a data burst in a relay station of a multi-hop relay system comprising a base station, the relay station, and a mobile station, the method comprising:
requesting the base station to assign a direct relay zone in a frame in which a demodulation and forwarding scheme that demodulates, and then modulates and transmits a data burst is applied; and
receiving an acknowledgement to the request from the base station.

2. The method of claim 1, further comprising relaying a data burst by using the frame in which the direct relay zone is assigned.

3. The method of claim 1, further comprising assigning the direct relay zone in the frame on the basis of a frame configuration arrangement message including information regarding the arrangement of the direct relay zone in the frame.

4. The method of claim 3, wherein the frame configuration arrangement message includes information, for each of a downlink sub-frame and an uplink sub-frame of the frame, regarding the existence of the direct relay zone, a symbol offset for a position where a direct receiving zone of the direct relay zone starts, a symbol offset for a position where a direct transmitting zone of the direct relay zone starts, and the number of symbols of the direct relay zone.

5. The method of claim 3, further comprising receiving the frame configuration arrangement message from the base station.

6. The method of claim 1, wherein a forward error correction (FEC) block size of a data burst in a link between the base station and the relay station is the same as that of a data burst in a link between the relay station and the mobile station.

7. The method of claim 1, wherein the requesting of the base station to assign the direct relay zone in the frame comprises sending a direct relay assignment request message including a type-length-value (TLV) indicating a capability to use the direct relay zone to the base station, and
the receiving of the acknowledgement to the request from the base station comprises receiving a direct relay assignment response message including the TLV indicating the capability to use the direct relay zone from the base station.

8. The method of claim 1, wherein the direct relay zone comprises:
a first direct relay zone located in a downlink sub-frame of the frame; and
a second direct relay zone located in an uplink sub-frame of the frame.

9. The method of claim 8, wherein the first direct relay zone comprises:
a first direct receiving zone located in a zone of the downlink sub-frame of the frame in which a data burst is received from the base station; and
a first direct transmitting zone located in a zone of the downlink sub-frame of the frame which is spaced apart by a predetermined gap from the first direct receiving zone and in which a data burst received from the first direct receiving zone is demodulated, and then modulated and allocated.

10. The method of claim 8, wherein the second direct relay zone comprises:
a second direct receiving zone located in a zone of the uplink sub-frame of the frame in which a data burst is received from the mobile station; and
a second direct transmitting zone located in a zone of the uplink sub-frame of the frame which is spaced apart by a predetermined gap from the second direct receiving zone and in which a data burst received from the second direct receiving zone is demodulated, and then modulated and allocated.

11. A multi-hop relay system comprising a relay system relaying a data burst between a base station and a mobile station,
wherein the relay station requests the base station to assign a direct relay zone in a frame in which a demodulation and forwarding scheme, which demodulates, and then modulates and transmits a data burst is applied, and receives an acknowledgement to the request from the base station.

12. The multi-hop relay system of claim 11, wherein the relay station assigns the direct relay zone in the frame on the basis of a frame configuration arrangement message including information regarding the arrangement of the direct relay zone in the frame.

13. The multi-hop relay system of claim 12, wherein the frame configuration arrangement message includes information, for each of a downlink sub-frame and an uplink sub-frame of the frame, regarding the existence of the direct relay zone, a symbol offset for a position where a direct receiving zone of the direct relay zone starts, a symbol offset for a position where a direct transmitting zone of the direct relay zone starts, and the number of symbols of the direct relay zone.

14. The multi-hop relay system of claim 11, wherein a FEC block size of a data burst in a link between the base station and the relay station is the same as that of a data burst in a link between the relay station and the mobile station.

15. The multi-hop relay system of claim 11, wherein the relay station transmits a direct relay assignment request message including a TLV indicating a capability to use the direct relay zone to the base station, and receives a direct relay assignment request response message including the TLV indicating the capability to use the direct relay zone from the base station.

16. A computer-readable recording medium having embodied thereon a program for executing a method of relaying a data burst in a relay station of a multi-hop relay system comprising a base station, the relay station, and a mobile station, wherein the method comprises:
requesting the base station to assign a direct relay zone in a frame in which a demodulation and forwarding scheme that demodulates, and then modulates and transmits a data burst is applied; and
receiving an acknowledgement to the request from the base station.

17. The computer-readable recording medium of claim 16, wherein the method further comprises assigning the direct relay zone in the frame on the basis of a frame configuration arrangement message including information regarding the arrangement of the direct relay zone in the frame.

18. The computer-readable recording medium of claim 16, wherein the frame configuration arrangement message includes information, for each of a downlink sub-frame and an uplink sub-frame of the frame, regarding the existence of the direct relay zone, a symbol offset for a position where a direct receiving zone of the direct relay zone starts, a symbol offset for a position where a direct transmitting zone of the direct relay zone starts, and the number of symbols of the direct relay zone.

19. The computer-readable recording medium of claim 16, wherein a FEC block size of a data burst in a link between the base station and the relay station is the same as that of a data burst in a link between the relay station and the mobile station.

20. The computer-readable recording medium of claim 16, wherein the requesting of the base station to assign the direct relay zone comprises sending a direct relay assignment request message including a TLV indicating a capability to use the direct relay zone to the base station, and
the receiving of the acknowledgement to the request from the base station comprises receiving a direct relay assignment request response message including the TLV indicating the capability to use the direct relay zone from the base station.

21. A computer-readable recording medium having embodied thereon a frame structure of a relay station comprising a downlink sub-frame and an uplink sub-frame in a multi-hop relay system comprising a base station, the relay station, and a mobile station, wherein the frame structure of the relay station comprises:
a first direct relay zone located in the downlink sub-frame and using a demodulation and forwarding scheme that demodulates, and then modulates and transmits a data burst; and
a second direct relay zone located in the uplink sub-frame and using the demodulation and forwarding scheme.

22. The computer-readable recording medium of claim 21, wherein the first direct relay zone comprises:
a direct receiving zone in which a data burst is received;
a direct transmitting zone in which a data burst received from the direct receiving zone is demodulated, and then modulated and transmitted; and
a gap zone located between the direct receiving zone and the direct transmitting zone.

23. The computer-readable recording medium of claim 21, wherein the second direct relay zone comprises:
a direct receiving zone in which a data burst is received;
a direct transmitting zone in which a data burst received from the direct receiving zone is demodulated, and then modulated and transmitted; and
a gap zone located between the direct receiving zone and the direct transmitting zone.
